(19) United States
(12) Patent Application Publication
(10) Pub. No.: US 2004/0175678 A1
(43) Pub. Date: Sep. 9, 2004

(54) Unique, new reading method for children's picture books

(76) Inventor: Nancy Ann Marx, Warrenton, VA (US)

Correspondence Address: Nancy A. Marx, 7010 Skyland Drive, Warrenton, VA, 20187, US

(21) Appl. No.: 10/691,659

(22) Filed: Oct. 24, 2003

Related U.S. Application Data
(60) Provisional application No. 60/421,073, filed on Oct. 25, 2002.

(51) Int. Cl. G09B 17/00

(52) U.S. Cl. 434/178

(57) ABSTRACT

Finally! . . . No longer do teachers, librarians, or anyone reading to a group have to stop to show the pictures to their audience. A unique idea has been presented for invention that allows the audience to always see the pictures of a picture book while the story is being read from the back two pages of the book! Numbered tabs allow smooth turning from one picture to the next while continuing to read the story from those back pages. There is also no need to remove the picture from the audience's view to answer questions. The pictures are also on the back pages along with the words.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### REFERENCE TO SEQUENCE LISTING, A TABLE, OR A COMPUTER PROGRAM LISTING COMPACT DISC APPENDIX

(Not Applicable)

### BACKGROUND OF THE INVENTION

Having read numerous picture books to numerous audiences of children, I can attest, as so many teachers like myself, librarians, and even parents can, to the kinked neck one gets from reading a children's picture book sideways and to the frustration that comes from constant interruptions to show the picture so “everyone” can see. This too often happens when reading the typical children's picture book to an audience of children.

To relieve the kinked neck and the frustrations of having to stop your flow of reading to show the pictures, I've invented a way to use/read a children's picture book that is most helpful to resolving the problems discussed above.

### BRIEF SUMMARY OF THE INVENTION

This invention is regarding the use/reading of children's picture books. Typically, when one reads the story to an audience, they read from the beginning of the book to the end by flipping one page after another from the right side of the book to the left. When reading to an audience, the reader will usually turn (kink) their head sideways to read the story sideways and will usually hold the book open partially to the audience in doing so. When this happens, only part of the audience gets to see the picture(s). The other part wants to see the pictures, so they end up interrupting the reader to show the pictures which interrupts the flow of the story, often poetry.

This invention, where the words and pictures of the story are printed on the back two pages of the book for the reader to fully view, the pictures are in full view of the audience, and a tab system is used to turn the pages, allows the whole audience to view the picture/illustrations at the same time, thereby reducing interruptions; reducing strain on the reader's neck and eyes; and allowing the reader to read the story continuously from beginning to end, having greater control over “when” to break and ask questions.

### BRIEF DESCRIPTION OF THE SEVERAL VIEWS OF THE DRAWING

FIG. 1—Picture, in landscape position, that shows the “full view” of the picture book's picture/illustration that the audience sees when book is fully-opened to them using this invention.

FIG. 2—Picture, in landscape position, that shows an example of how the “back two pages” can be set up to provide the words/text of the story, along with their respective pictures and tab numbers, along with how the tabs themselves show to the reader to be used to turn to the next page when through reading the previous one.

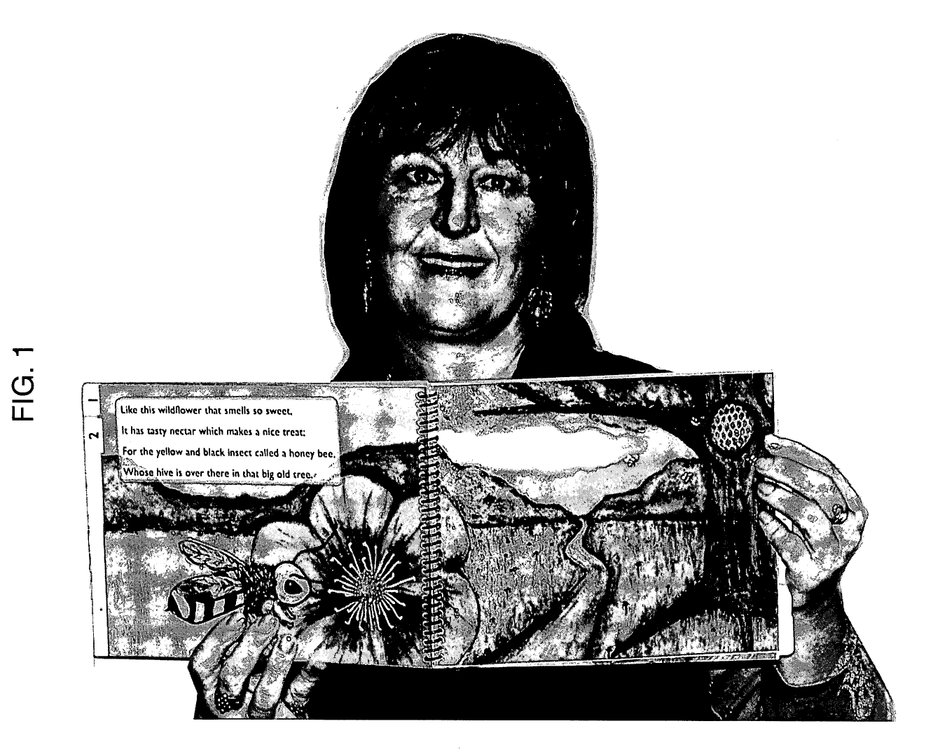

FIG. 1A—Picture the same as in FIG. 1, but smaller and laid-out in portrait.

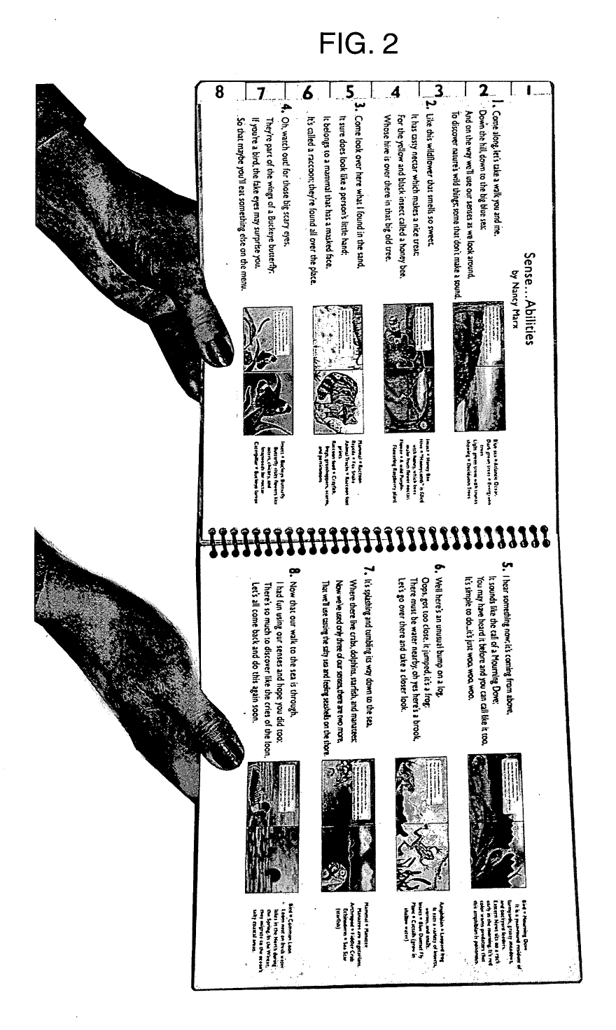

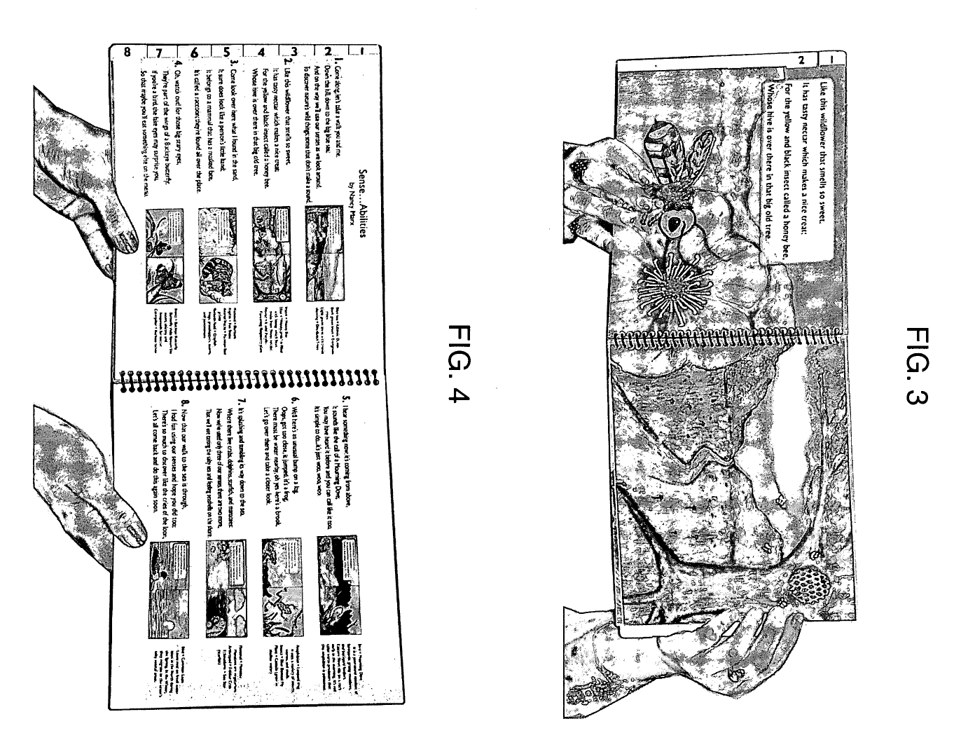

FIG. 2A—Picture the same as in FIG. 2, but smaller and laid-out in portrait.

FIG. 3—Pictures from FIGS. 1 and 2 that are smaller and laid-out in portrait.

### DETAILED DESCRIPTION OF THE INVENTION

For the purposes of this description, a Children's Picture Book is any book that by any description, fits into this GENRE for children's reading material. Therefore, this GENRE typically has pictures/illustrations and text/stories that goes along with those pictures.

While this invention could influence the future “design” of children's picture books, it's purpose is to show how much more useful and functional to the reader of children's picture books and their audience it would be if this idea were considered in the publication of future children's picture books.

The idea is simple. The story's words/text, respective pictures, and the page numbers of the story (book) are printed/shown on the back two pages of the book, generally, but not limited to the inside part of the back cover and the back side of the last page of the book. The text of the story/words, pictures, and page numbers are printed in a manner that allows the reader to read continuously from one page to the next as in the story itself in the regular pages of the book.

The book is bound in a manner such as, but not limited to spiral or coil binding so that the book's back pages can be fully opened to the reader and the first of several pictures can be fully opened to the audience.

A tabbing system is used in conjunction with the words and pictures that allow the reader to easily turn the next picture to the audience for their full view and easily continue reading the story from there on the back pages. These tabs are a part of the inside picture pages of the book. The page numbered tabs (facing the reader) on each picture page, correspond with the number of the page on the back pages that the reader sees which is next to the text for that page they are reading. When through reading page 1 (Tab 1), the reader uses Tab 2 (page 2) to flip to the next picture/page and continues using this system until through reading the story.

The cover(s) and inside pages are to be sturdy enough so when the book is opened to read from those back pages, it can be securely held in a horizontal position and the covers won't bend much and the pages won't rip or bend much either when turning them with the tabs.

The ideas presented herein are not limited to a particular size, shape, or thickness of picture book. They are not limited to a particular type of binding, only that whatever is used allows the reader's pages and the book's pictures to be fully opened to the reader and the audience respectively. They are not limited to the words being placed horizontally as in the example or vertically or otherwise and the same holds true for the pictures, only that they stay with the respective words/text. They are not limited to a certain font, size or style of character, nor are the size or color or exactness of the pictures on the back pages limited to the example. They are also not limited to any particular shape of tab (i.e., curved, square) or must be place on the side. They could also be on the top.

What is claimed is:

1. A process for providing an easier, more effective way to read children's picture books to an audience of children which is comprised of a picture book's words/text, respective pictures, and page numbers of the story (book) printed/shown on the back two pages of the book (one page being the back cover's inside page and the other being the back side of the last page in the book) in a manner that allows the reader to continuously read from one page to the next as one would read from the pages of the story itself from beginning to end; of a binding system that allows the book to be fully opened horizontally so that the two back pages are fully open to the reader and at the same time, the picture page(s) of the book is fully open to the audience; of a numbered tabbing system that corresponds to the page numbers next to the text the reader is reading on the back pages and allows the reader to use the tabs to easily flip to the next picture/page that the audience is viewing and continue using said system until through reading the story; and of materials used to manufacture the cover and pages that ensure a sturdiness of them so that when held in an open position, won't bend excessively and the pages won't rip or bend excessively when turning them with the tabs.

2. The process according to claim 1, wherein said system for reading of children's picture book is comprised of but not limited to a particular size, shape, or thickness of picture book; a particular type of binding, only that whatever is used allows the reader's pages and the book's picture(s) to be fully opened to the reader and the audience respectively; to the words being placed horizontally as in the example or vertically or otherwise and the same holds true for the pictures and numbers, only that they stay with the respective words/text; a certain font, size or style of character, only that they are large enough for the reader to see, nor are the size or color or exactness of the pictures on the back pages limited to the example; and is not limited to any particular shape of tab (i.e., curved, square) nor must they be placed on any particular side or top, only that they are convenient for the reader to turn.
